(19) United States
(12) Patent Application Publication
(10) Pub. No.: US 2011/0013012 A1
(43) Pub. Date: Jan. 20, 2011

(54) METHOD AND APPARATUS FOR DETERMINING THE DEFORMATION OF A FUEL ASSEMBLY OF A PRESSURIZED WATER REACTOR

(75) Inventors: Wolfgang Hummel, Neumarkt (DE); Timo Feller, Nurnberg (DE)

Correspondence Address: LERNER GREENBERG STEMER LLP, P O BOX 2480, HOLLYWOOD, FL, 33022-2480, US

(73) Assignee: AREVA NP GMBH, Erlangen (DE)

(21) Appl. No.: 12/839,441

(22) Filed: Jul. 20, 2010

(30) Foreign Application Priority Data
Jul. 20, 2009 (DE) 10 2009 027 831.1
Aug. 21, 2009 (DE) 10 2009 028 793.0

(51) Int. Cl. G06T 7/00; H04N 7/18

(52) U.S. Cl. 348/81; 382/100; 348/E07.085

(57) ABSTRACT

In a method for ascertaining the deformation of a fuel assembly in a pressurized-water reactor, the fuel assembly is placed in a measurement station located inside a flooded pool. The measurement station has a holding apparatus for accommodating and fixing the fuel assembly and also a camera which can be moved at least approximately parallel to its bearing axis. Digital images of the fuel assembly are recorded and stored using the camera in various axial positions, in which in each case one selected structural element of the fuel assembly is located, with the position of the fuel assembly in the recorded image depending on the deformation of the fuel assembly. Each recorded image is segmented using methods of digital image processing, and the selected structural element is identified by comparison with a virtual image of the structural element. Subsequently, for at least one selected reference element of the structural element, the spatial position of which is known from the deformation of the fuel assembly, at least one image coordinate is automatically ascertained and assigned to an object coordinate using a previously known imaging scale.

The invention relates to a method and to an apparatus for ascertaining the deformation of a fuel assembly in a pressurized-water reactor.

Depending on their position in the core, the fuel assemblies in a pressurized-water reactor can over the course of their operation experience a deformation which consists substantially of a bending, and the deformation can, in the worst case scenario, result in an unwieldiness of the control rods or in difficulties during the fuel-assembly exchange. It is therefore necessary during an inspection of fuel assemblies to determine the deformation of such a fuel assembly in a quantitative fashion in order to be able to make a decision regarding their ability to be used further or in order to use them, as is proposed, for example, in WO 02/095765 A2, at the edge of the core in an orientation such that the maximum of bending is situated at the outside of the core in order to thus reduce any bending present.

A method for ascertaining the bending of a fuel assembly is known, for example, from JP 10282286 A. In this method, a video camera, which can be moved parallel to the fuel assembly, is used to detect the curved profile of a fuel rod between an upper and a lower structural element. JP 02176506 A discloses an apparatus which is used to detect the dimensions of a fuel assembly with the aid of a camera, additionally using a distance measuring device, with which the distance between the camera and the fuel assembly is measured, in order to correct the size of the image, which size varies on account of bending.

The invention is therefore based on the object of specifying a method for ascertaining the deformation of a fuel assembly in a pressurized-water reactor, which method can be carried out simply and with little expenditure of time. In addition, the invention is based on the object of specifying an apparatus which operates according to this method.

With respect to the method, the stated object is achieved according to the invention by way of a method having the features of patent claim 1. This method comprises the following steps:
a) the fuel assembly is arranged in a measurement station located inside a flooded pool,
b) the measurement station comprises a holding apparatus for accommodating and fixing the fuel assembly and also a camera which can be moved at least approximately parallel to its bearing axis,
c) digital images of the fuel assembly are recorded and stored using the camera in various axial positions, in which in each case one structural element of the fuel assembly detectable in the recorded image is located, with the position of the fuel assembly in the recorded image depending on the deformation of the fuel assembly,
d) each recorded image is segmented at least in a sectional manner using methods of digital image processing,
e) in the segmented image, the structural element is identified by comparison with a virtual image of the structural element which is associated with said recorded position,
f) for at least one selected reference element of the structural element, the spatial position of which depends on the bending of the fuel assembly, at least one image coordinate is automatically ascertained and assigned to an object coordinate using a previously known imaging scale.

On account of the detection, which is carried out using such an automated photogrammetric measurement, of the object coordinate of a reference element the position of which in space (object coordinate) depends on a deformation of the fuel assembly and enables the quantitative determination thereof, for example a point or a vertical line the distance of which from the lateral edge or corner of the fuel assembly is known, there is a significant reduction in the time expended in ascertaining the deformation.

Within the meaning of the present invention, a structural element can be, for example, the contour of a structural part of the fuel assembly, for example the outer contour of a fuel rod, the contour of a spacer, of the foot part or of the head part of the fuel assembly, or the contour of a bore, of a slot or of a deflector vane in such a spacer.

The invention is based here on the consideration that a direct detection, which is carried out with methods of digital image processing, of the lateral outside edge of the spacer, which extends in the longitudinal direction, can be used in many cases to ascertain the actual position of this outside edge (corner) only inaccurately. The reasons for this are, firstly, the unfavorable illumination conditions, which make it difficult in particular to detect the lateral edge or the corner of an edge web of the spacer. Distinct segmentation of the edge is also made more difficult since the fuel assembly may not just be bent in one direction but can additionally also be twisted, with the result that in the recorded image two edges or corners which are located near each other are imaged, but can no longer be reliably separated from each other due to the unfavorable illumination conditions.

Since, according to the present invention, segmentation of a structural element is performed which is distinctly identifiable in the image with the aid of its virtual image and in which a selected reference element, which can be reliably localized, is located, and of which the spatial position depends on the bending of the fuel assembly, it is possible to make use of structures in the real image which can be reliably and automatically detected even if the illumination conditions are poor.

In each recorded image, the segmented structural element is preferably made to coincide with a virtual image of said structural element—the reference structure—, and the virtual image of the reference element is used as the at least one selected reference element to determine the object coordinate. In other words, the position of the reference element is not measured directly with the recorded image of the structural element but rather using the virtual reference structure, the position of which is fixed in the image with the aid of the segmented structural element. In this manner, the accuracy of the measurement is increased.

If at least a plurality of the structural elements recorded in various axial positions in the image are structurally identical and the selected reference elements correspond to one another, the measurement is additionally simplified and accordingly speeded up.

If the imaging scale is determined with the aid of known dimensions of structures of the fuel assembly which are displayed in the image, errors caused by tolerances of the position of the camera or of the position of the fuel assembly in the holding apparatus are largely eliminated.

With respect to the apparatus, the stated object is achieved by way of an apparatus having the features of patent claim 5, the advantages of which correspond analogously to the advantages respectively specified in relation to the method claims.

For further explanations of the invention, reference is made to the exemplary embodiment of the drawing, in which:

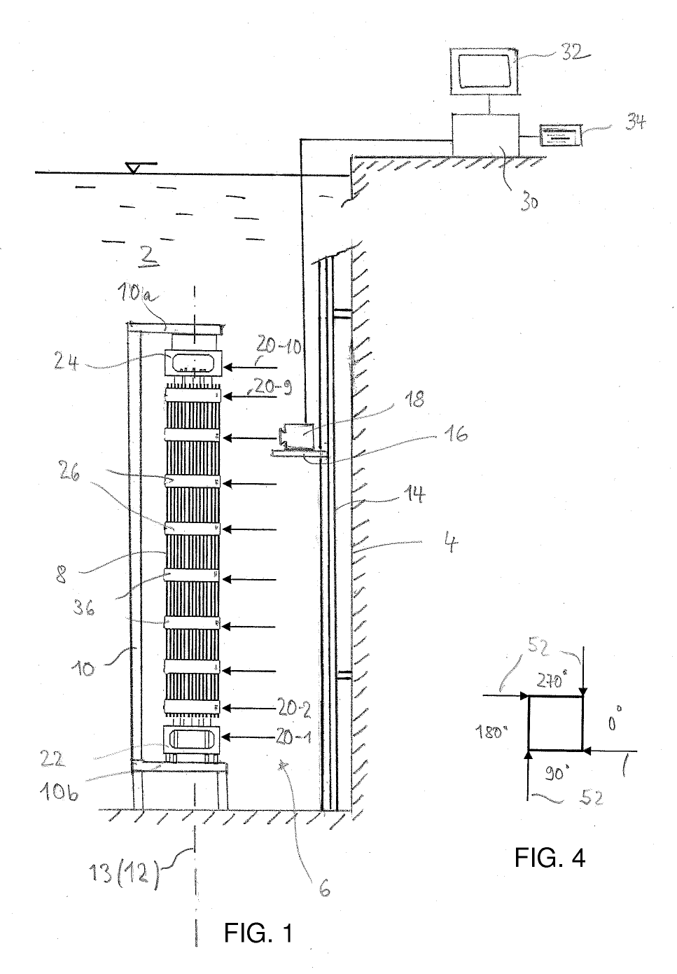

FIG. 1 shows an apparatus according to the invention in a basic schematic,

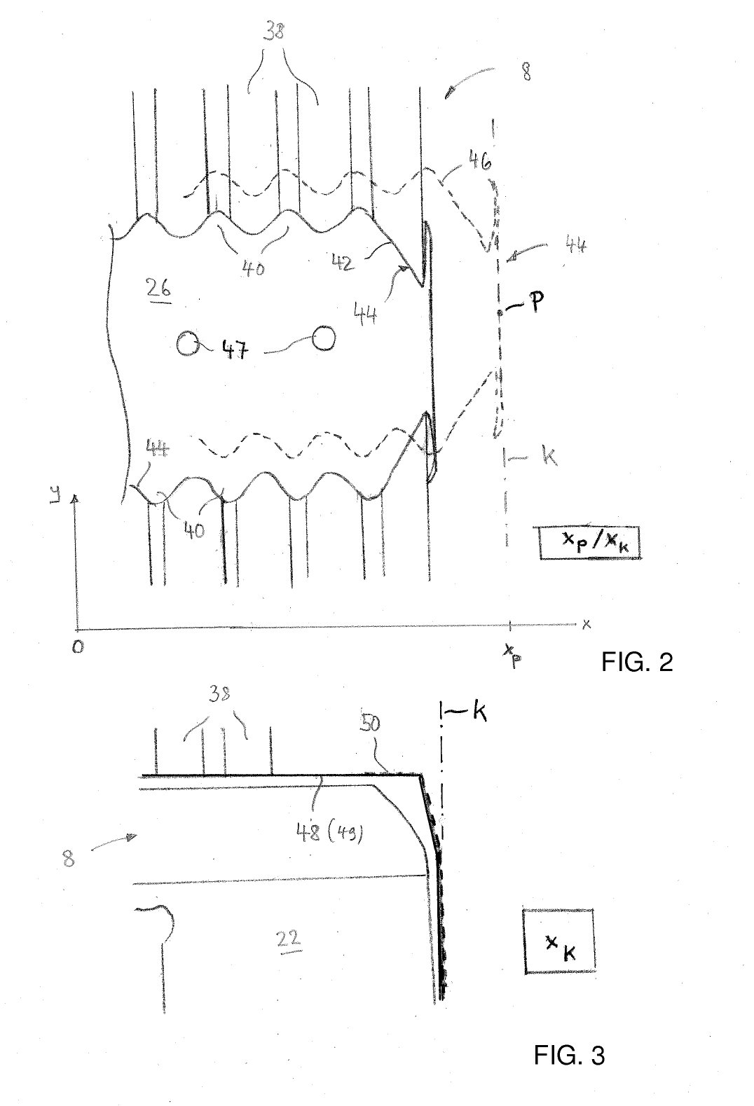

FIGS. 2 and 3 each show images, recorded with the camera, of a fuel assembly in the region of a spacer or in the region of its foot part,

FIG. 4 shows an idealized schematic of the measurement positions of the camera which are possible on account of the rotation of the fuel assembly in the measurement station.

According to FIG. 1, a measurement station 6 for measuring the deformation of a fuel assembly 8 is arranged in a pool 4, for example the fuel-assembly storage pool, in a pressurized-water reactor plant, which pool 4 is flooded with water 2. The measurement station 6 comprises a holding apparatus 10 with an upper and a lower receptacle 10a and 10b, between which the fuel assembly 8 is accommodated and fixed in a position in which the longitudinal axis 12 thereof is, in the ideal case, i.e. if the fuel assembly 8 is not bent, aligned parallel to an at least approximately vertically aligned bearing axis 13 of the holding apparatus 10.

A rail 14, on which a carriage 16 carrying a camera 18 is mounted, is arranged on a side wall of the pool 4 and at least approximately parallel to the bearing axis 13 of the holding apparatus 10, i.e. likewise at least approximately vertically aligned. This carriage 16 can be used to move the camera 18 along the rail 14 and to position it opposite the fuel assembly 8 in various axial (height) positions, as is illustrated in the figure by the positions 20-1 to 20-10 shown with arrows.

Fuel assembly 8 and camera 18 are positioned relative to each other such that the optical axis of the camera extends at least approximately perpendicular to a side face, which faces the camera, of a non-bent and untwisted fuel assembly 8 in order to produce an image, which is largely free of perspective distortions, in plan view of the fuel assembly 8. In principle, it is also possible, however, to computationally eliminate distortions, which arise from non-exact perpendicular alignment, using image processing software on the basis of the recording of an object with a straight line located on the latter.

The camera 18 is moved successively to the different positions 20-1 to 20-10. In the example illustrated, the camera is moved to a position 20-1 in the region of the foot part 22 and to a position 20-10 in the region of the head part 24 and to positions 20-2 to 20-9 in the region of the spacers 26 of the fuel assembly 8.

The images recorded by the camera 18 in these positions 20-1 to 20-10 are displayed on a monitor 32, which is connected to a control and evaluation unit 30, and stored in an image memory. The control and evaluation unit 30 comprises an image processing unit which is implemented in the former as software and whose functioning will be explained in more detail below. The figure also illustrates an input unit 34, for example a keyboard and a mouse, for manually inputting control commands.

FIG. 2 now shows a digital image, recorded by the camera 18, of the fuel assembly 8 in the region of one of its spacers 26. The figure shows that at its upper and lower edges the spacer 26 has vanes 40, which is directed into the inside of the fuel assembly 8 and protrude between the fuel rods, with the vanes not only serving for deflecting the cooling water which during operation flows in the inside of the fuel assembly 8, but also having the function of preventing the fuel assemblies 8 from catching on something during loading and unloading. Also drawn in the figure is an image coordinate system x, y which can be seen by the observer on the monitor for example in the form of a scale and which, with the imaging scale being known, directly displays real object coordinates in metric units rather than pixel values.

The recorded image is now segmented using methods of digital image processing with software which is implemented in the control and evaluation unit 30, in order to enable the identification of a selected structural element, the position of which in the image depends on the deformation of the fuel assembly 8. In the example, this is the image 42 of the contour 44 of the spacer 26 displayed in the recorded image.

Drawn in dashed lines in the figure is additionally a virtual image 46 of the contour 44 of the spacer 26 which is installed in the axial position, where the camera 18 is located, in the fuel assembly 8. This virtual image 46 serves as a reference structure and is stored in an image memory of the control and evaluation unit 30 (illustrated in FIG. 1) for the respectively relevant type of fuel assembly or spacer. The structural element required for the evaluation, i.e. in the example the recorded image 42 of the contour 44, is identified by comparison of the structures which are segmented in the recorded image with the virtual image 46. In other words, the contour 44 of the spacer 26 serves in the illustrated example as the identifiable structural element.

In the case when a fuel assembly 8, for which no virtual image of a structural element that is suitable for the measurement exists, is to be measured, it is possible within the framework of referencing to produce such a virtual image in situ by selecting a structural element and manually tracing it for example with the aid of a cursor. In this manner, a structural element which is intended to be the reference structure is localized in the recorded image. In the direct vicinity of the line traced by the cursor a segmentation is now carried out. The contour of the structural element, which was ascertained during the segmentation, for example likewise the contour of the spacer, is stored as a virtual image and is used as the reference structure for the subsequent measurements.

The real image 42 is now superposed onto the virtual image 46, i.e. the real and virtual images 42 and 46 are displaced relative to each other until the geometric deviation between the real and virtual images 42 and 46 is minimal.

In the virtual image 46, a point P is defined as a reference element whose spatial position depends on the bending of the fuel assembly 8; it lies on the lateral outer line K of the virtual image 46, the image position x_{P} of which is automatically ascertained in the direction of the x-axis of the image coordinate system and is shown on the monitor in pixel units or in object-related metric units. In principle, it is also possible for a plurality of points rather than just a single point to be detected. Alternatively, the outer line k, the horizontal position x_{K} of which likewise directly corresponds to the actual position of the lateral edges of the fuel assembly 8, is a suitable reference element.

In the case of this superposition, it may additionally be necessary to increase or decrease the size of the virtual image 46, and in this manner to ascertain or correct the actual imaging scale of the camera and to make the real image 43 and the virtual image largely coincide.

The subsequently ascertained image coordinate x_{P} for point P directly represents the real position of an outside edge of the fuel assembly 8.

In FIG. 2, in addition and by way of example, further identifiable structural elements in the form of bores 47 are drawn in the real image of the spacer 26, and, for control purposes or for the case that the imaging scale is not known a priori, these structural elements likewise can be used to measure the imaging scale of the image, i.e. the ratio of pixel distances to real location distances, when the dimensions thereof and mutual distance is known.

Moreover, such easily identifiable or distinctly segmentable structural elements can also be stored in the form of a virtual image and can be used to identify the spatial position of the spacer 26 and thus the position of the lateral edge if these can be used to fix a reference element the distance of which from the lateral edge is known.

In the same manner, the positions of the outside edges of the head part and of the foot part of the fuel assembly can be measured, as is illustrated in FIG. 3 for the foot part 22. Here, too, a contour 48 of the foot part 22 serves as the identifiable structural element, onto the real image 49 of which is superposed a virtual image 50 (shown in dashed lines) of the contour 48, i.e. they are made to coincide as is illustrated in the figure. In this case, too, a vertical line K, representing the position of the outside edge, of the virtual image 50 serves as the selected reference element.

Alternatively, is sufficient in the region of head part and foot part to detect the position of the outside edge directly by way of segmentation of the image, without the need of a virtual image of its contour in this case, since practice has shown that the outside edges thereof can be more distinctly identified than the outside edges of spacers.

If the spatial coordinate x_{P}, x_{K} of the same reference structure P, K is ascertained in all positions 20-1 to 20-10, the distance thereof from the outside edge of the fuel assembly 8 does not need to be known in principle, since in this case knowledge of the relative positions suffices for quantitatively detecting a bending of the fuel assembly 8.

After the measurement in all positions 20-1 to 20-10 is complete, the fuel assembly 8 is rotated by 90° and fresh measurements are made so that the fuel assembly is investigated from all four sides for any occurrence of a deformation, as is shown by arrows in FIG. 4. Since all four lateral edges or corners of the fuel assembly are measured, it is possible to computationally eliminate system-induced error sources, such as deviation of the bearing axis from the vertical, no exactly parallel orientation of rail and bearing axis, bearing axis and longitudinal axis of the (unbent) fuel assembly failing to coincide, camera not moving exactly along a linear path, and it is possible not only to detect the direction of the bending, but additionally also a twisting of the fuel assembly 8 about its longitudinal axis can be measured.

In the exemplary embodiment illustrated, structural components of spacers were used as the selected structural or reference elements. However, in principle it is likewise possible for fuel rods in specific positions, such as the fuel rods arranged in the region of a corner, to be used as structural elements.

1-5. (canceled)

6. A method for ascertaining a deformation of a fuel assembly of a pressurized-water reactor, the method which comprises:
a) placing the fuel assembly in a measurement station located inside a flooded pool;
b) the measurement station having a holding apparatus for accommodating and fixing the fuel assembly and a camera mounted for movement substantially parallel to a bearing axis of the holding apparatus;
c) recording and storing a plurality of digital images of the fuel assembly with the camera in various axial positions, in which in each case one structural element of the fuel assembly detectable in the recorded image is located, with the position of the structural element in the recorded image depending on the deformation of the fuel assembly;
d) segmenting each recorded image at least in sections using a digital image processing method to form a segmented image;
e) identifying the structural element in the segmented image by comparison with a virtual image of the structural element associated with the recorded position;
f) for at least one selected reference element of the structural element, the spatial position of which depends on the deformation of the fuel assembly, automatically ascertaining at least one image coordinate and assigning the at least one image coordinate to an object coordinate using a predetermined imaging scale; and
g) determining therefrom a degree of deformation of the fuel assembly.

7. The method according to claim 6, which comprises, in each recorded image, causing the segmented structural element to coincide with a virtual image of the structural element, and using the virtual image of the reference element as the at least one selected reference element to determine the object coordinate.

8. The method according to claim 6, wherein at least a plurality of the structural elements recorded in various axial positions in the image are structurally identical and the selected reference elements correspond to one another.

9. The method according to claim 6, which comprises determining the imaging scale with the aid of known dimensions of structures of the fuel assembly present in the image.

10. An apparatus for ascertaining a deformation of a fuel assembly in a pressurized-water reactor, comprising:
a) a measurement station located inside a flooded pool, said measurement station having a holding apparatus for accommodating and fixing the fuel assembly and said holding apparatus having a bearing axis;
b) a rail disposed next to said holding apparatus at least approximately parallel to said bearing axis thereof, a carriage moveably mounted on said rail, and a camera mounted on said carriage for recording digital images of the fuel assembly;
c) a monitor for displaying the real images; and
d) a control and evaluation unit having software implemented therein which, when loaded into a main memory of said control and evaluation unit, carries out the method according to claim 6.
